(19) United States
(12) Patent Application Publication
(10) Pub. No.: US 2020/0211560 A1
(43) Pub. Date: Jul. 2, 2020

(54) Data Processing Device and Method for Performing Speech-Based Human Machine Interaction

(71) Applicant: Bayerische Motoren Werke Aktiengesellschaft, Muenchen (DE)

(72) Inventors: Wenhui LEI, Shanghai (CN); Felix SCHWARZ, Muenchen (DE); Thurid VOGT, Augsburg (DE)

(21) Appl. No.: 16/818,758

(22) Filed: Mar. 13, 2020

Related U.S. Application Data
(63) Continuation of application No. PCT/CN2017/101954, filed on Sep. 15, 2017.

(51) Int. Cl. G10L 15/22; G10L 15/18; G10L 15/26; H04M 3/50

(52) U.S. Cl. CPC G10L 15/22; G10L 15/1822; G10L 2015/225; H04M 3/50; G10L 15/26

(57) ABSTRACT

A method for performing speech-based human machine interaction (HMI) includes obtaining a speech of a user and determining whether a response to the speech of the user can be generated. If no response can be generated, information is sent corresponding to the speech of the user to the call center. A data processing device for performing speech-based human machine interaction (HMI), includes an obtaining module to obtain a speech of a user. The data processing device further includes a determining module to determine whether a response to the speech of the user can be generated. The data processing device further includes a sending module to send information corresponding to the speech of the user to the call center.

### CROSS REFERENCE TO RELATED APPLICATION

This application is a continuation of PCT International Application No. PCT/CN2017/101954, filed Sep. 15, 2017, the entire disclosure of which is herein expressly incorporated by reference.

### BACKGROUND AND SUMMARY OF THE INVENTION

The present subject matter relates in general to the field of human machine interaction, HMI, and in more particular, to a method and an apparatus for performing speech-based human machine interaction, particularly in vehicle.

With the rapid development of technology and frequently daily usage, Speech Recognition (SR) is widely used in many branches and scenarios, e.g. SIRI® of Apple Inc., are very widely known. It could be very useful daily personal assistant. Recently the personal assistant function based on speech recognition technology is also implemented in in-car navigation and infotainment systems. Benefitting from better trained models with deep learning, and large amounts of data collected from user with mobile internet, the performance of Speech Recognition is also improving.

The Natural Language Understanding (NLU) technology has been improved significantly, which make the speech-based Human Machine Interaction (HMI) more natural and intelligent. Unlike so-called command-based control system five years ago, NLU can understand the driver/user correctly and respond to the user's question in many fields, such as setting navigation, finding a point of interest (POI) in a certain areas, turning on the radio, playing a song, etc. The above mentioned speech-based Human Machine Interaction functions are known as artificial intelligence (AI), which uses no or few human interaction to answer a driver's question.

However, due to various reasons, such as the speaker's accent, unusual speaking style, outer-site unknown destination names, the Speech Recognition and NLU sometimes cannot correctly understand what the driver asked or cannot find the corresponding response. Sometimes, it is hard for even a native speaker to understand questions the user wants to ask because languages in combination with different accents could be varying and flexible. For example, according to a survey, there are 12 different expressions in Chinese to state how to turn on a function in the car. It is impossible for the current AI system, e.g. NLU, to understand all of the different expressions and accents. Even if the SR and NLU technology is mature enough, there are still failures in the case where the POI is not in database, or the user speaks in an unusual accent.

Another problem is about the dialog design for HMI, especially when the Speech Recognition and/or NLU system fails, the AI system will normally ask the driver repeatedly to ask question again, which cannot help in such a situation and sometimes makes the driver even confused what he could do.

Currently, most users would rather call the concierge service (call center) in order to speak to a human assistant rather than use the AI assistant system, where the agency will answer the driver's question. A call center is a centralized office used for receiving or transmitting a large volume of requests by telephone. An inbound call center is operated by a company to administer incoming service support or information inquiries from consumers. The call center agents are equipped with computer, a telephone set/headset connected to a telecom switch, and one or more supervisor stations. It can be independently operated or networked with additional centers, often linked to a corporate computer network, including mainframes, microcomputers and LANs. Increasingly, the voice and data pathways into the center are linked through a set of new technologies called computer telephony integration.

If the in-car system would trigger the human concierge service, then an agency in the call center will take over the service. The agency can interact with the driver and solve problem the driver has. However, in this case, the driver has to repeat his question and requirement to the human assistant.

The task of the present subject matter is to provide a method and a device that can solve the user's question in a case where the AI-based system fails.

Embodiments of the present subject matter provide a method, a device and a vehicle for performing speech-based human machine interaction, which enable an efficient and comfortable user experience when the AI-based system is not able to answer questions of the user due for various reasons.

Accordingly, a computer-implemented method for performing speech-based human machine interaction is provided. The method comprises: receiving a speech of a user; determining whether a response to the speech of the user can be generated; and if no response can be generated, sending information corresponding to the speech of the user to the call center.

Firstly, the car, especially the in-car navigation or infotainment system, obtains the voice speech from the driver, and then transfers it to the AI assistant system, which could be an onboard system, off-board system or a hybrid system. If the AI system is able to answer the question correctly, the in-car AI assistant system will reply the driver though the in-car interface, e.g. speaker and display. According to the present subject matter, when in-car AI assistant system fails to generate a response to the driver's question, information according to the speech will be sent to the human assistant in the call center via communication network. Therefore, the human assistant in the call center knows the intention of the user by checking the information corresponding to the speech of the driver and can prepare the solution and answer before communicating with the driver.

Advantageously, the driver/user does not need to repeat his question again to the agent. Furthermore, the information corresponding to the speech, especially the semantic analysis, will help the human assistant a lot to catch user's intention. Service efficiency and quality of the call center can also be improved.

In a possible implementation manner, the method further comprises: establishing a phone call between the user and a call center.

In a further possible implementation manner, the step “determining whether a response to the speech of the user can be generated” comprises: recognizing, by using natural language understanding, NLU, an intention of the user according to the speech.

In a further possible implementation manner, the step “determining whether a response to the speech of the user can be generated” further comprises: generating the response according to the recognized intention of the user; and deciding whether the response can be generated by the step “generating the response according to the recognized intention of the user.”

The AI-based assistant service is still the first choice for the driver, which could answer most of questions very quickly without waiting a long time. The human assistant service (so-called concierge service) can be automatically triggered, when AI-based assistant system fails to give a suitable answer.

In another further possible implementation manner, the step of “sending information corresponding to the speech of the user to the call center” comprises: storing the speech of the user; and sending the speech to the call center.

In another further possible implementation manner, the step “sending information corresponding to the speech of the user to the call center” comprises: generating text information according to the speech; and sending the text information to the call center.

When in-car AI assistant system fails to generate a response to the driver's question, information such as a voice speech of the driver and/or a text message will be sent to the human assistant in the call center via communication network. Especially, the user's questions/speech will be translated into text. Therefore, the human assistant in the call center knows the intention of the user by checking the information corresponding to the speech of the driver and can thus prepare the solution and answer before communicating with the driver.

According to a further aspect, a data processing device for performing speech-based human machine interaction, HMI, is provided. The data processing device comprises: an obtaining module adapted to obtain a speech of a user; a determining module adapted to determine whether a response to the speech of the user can be generated; and a sending module adapted to send information corresponding to the speech of the user to the call center.

In a possible implementation manner, the data processing device further comprises an establishing module adapted to establish a phone call between the user and a call center.

In a further possible implementation manner, the determining module comprises a recognizing module adapted to recognize, by using natural language understanding, NLU, an intention of the user according to the speech.

In another further possible implementation manner, the determining module further comprises: a response generating module adapted to generate the response according to the recognized intention of the user; and a deciding module adapted to decide whether the response can be generated by the response generating module.

In another further possible implementation manner, the sending module comprises: a storing module adapted to store the speech of the user; and a speech sending module adapted to send the speech to the call center.

In another further possible implementation manner, the sending module comprises: a generating module adapted to generate text information according to the speech; and a text sending module adapted to send the text information to the call center.

According to another further aspect, a vehicle comprising the above mentioned data processing device is provided.

Firstly, the car, especially the in-car navigation or infotainment system, receives the voice speech from the driver, and then transfers it to the AI assistant system, which could be an onboard system, off-board system or a hybrid system. If the AI system is able to answer the question correctly, the in-car AI assistant system will reply the driver though the in-car interface, e.g. speaker and display. According to the present subject matter, when in-car AI assistant system fails to generate a response to the driver's question, information such as a voice speech of the driver and/or a text message, which is generated by recognizing the meaning of the speech and translating it into the text, will be sent to the human assistant in the call center via communication network. Especially, the user's previous questions/speech will be sent to a SR/NLU module, which could help to extract its semantics and translate the speech into text. Therefore, the human assistant in the call center knows the intention of the user by checking the information corresponding to the speech of the driver and can thus prepare the solution and answer before communicating with the driver. Additionally, the important part of the text message can be highlighted.

Advantageously, the driver/user does not need to repeat his question again to the agent. Furthermore, the information corresponding to the speech, especially the semantic analysis, will help the human assistant a lot to catch user's intention. Service efficiency and quality of the call center can also be improved.

Other objects, advantages and novel features of the present subject matter will become apparent from the following detailed description of one or more preferred embodiments when considered in conjunction with the accompanying drawings.

### BRIEF DESCRIPTION OF THE DRAWINGS

To describe the technical solutions in the embodiments of the present subject matter more clearly, the following briefly introduces the accompanying drawings required for describing the embodiments. Apparently, the accompanying drawings in the following description show merely some embodiments of the present subject matter, and a person of ordinary skill in the art may still derive other drawings from these accompanying drawings without creative efforts.

FIG. 1 is a schematic diagram of a further embodiment of the method according to the present subject matter; and

FIG. 2 shows a schematic diagram of an embodiment of the data processing device according to the present subject matter.

### DETAILED DESCRIPTION OF THE DRAWINGS

The following clearly and completely describes the technical solutions in the embodiments of the present subject matter with reference to the accompanying drawings in the embodiments of the present subject matter. Apparently, the described embodiments are some but not all of the embodiments of the present subject matter. All other embodiments obtained by a person of ordinary skill in the art based on the embodiments of the present subject matter without creative efforts shall fall within the protection scope of the present subject matter.

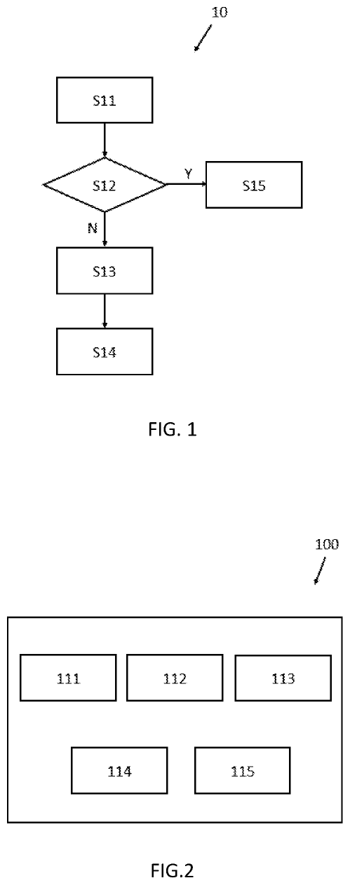

FIG. 1 shows a schematic flow chart diagram of an embodiment of the method 10 for performing speech-based human machine interaction for the in-car navigation or infotainment system, especially for answering questions from the driver or conducting operations ordered by the driver. The method can be implemented by a data processing device shown in FIG. 2, e.g. a processor with corresponding computer program.

In the first step S11 according to FIG. 1, the interface in car, e.g. a microphone, can receive the speech of the driver. In order to find a response to the driver, the speech is then transferred to the AI assistant system, which could be an onboard system, off-board system or a hybrid system.

In step S12, an intention of the user is recognized based on the speech of the driver, by using natural language understanding, NLU, technology. Then, the in-car assistant system tries to generate the response according to the recognized intention of the user, for example by using an artificial intelligence assistant module, which is configured to find the suitable response to the drive's requirement as well as to conduct the operation corresponding to the user's intention.

As mentioned afore, in some case the artificial intelligence assistant system cannot understand the user or cannot find a suitable answer to the question of the user. The in-car assistant system according to the present subject matter decides whether the suitable response can be generated by the artificial intelligence assistant module.

If it is determined in the step S12 that the in-car AI assistant module can understand and answer the driver correctly, according to step S15 the response corresponding to the question/voice of the driver will be sent to the driver though e.g. a speaker and display.

According to the step S13, if AI assistant does not able to understand the driver's speech or cannot find a suitable answer, information corresponding to the speech of the user will be sent to the call center.

Especially, the user's questions/speech will be sent to a speech recognition module or NLU module, which could help to translate voice into text and extract its semantics. The text message will be sent to the call center in order to initiate the human assistant service. Then before picking up the call, the human assistant can check the text message from the car and understand the meaning and intention of the driver. Additionally important parts/words in the text message can be highlighted according to the analysis of the speech recognition module.

Alternatively, a voice message comprising the speech of the driver can be sent to the call center, instead of the text message.

Especially, driver/user need not repeat his/her request again to the agent. The dialog design will let him/her know the AI service has failed because of some reasons, but a human agent will contact him/her immediately. In addition, the semantic analysis and the highlighted text will help a lot to the agent to catch the user's intention, because the call center agents normally do not have much time to read whole text or listen to the audio record, latency of call from driver is a critical criterion to evaluate his service quality.

In the step S14, the in-car assistant system can also establish the concierge call between the driver and the call center.

Accordingly, the AI-based assistant service is still the first choice for the driver, which could answer most of questions quickly without waiting a long time. The human assistant service (so-called concierge service) can be automatically triggered when AI-based assistant system fails to give a suitable answer.

Before answering the call, the call center agents are able to know the general information and intention of the driver, therefore, the request and/or question must not be repeated to the call center assistant. When the call is connected, the agent would ask you to confirm your intention or directly provide the driver with suitable solutions. The user experience is thus improved.

FIG. 2 shows a schematic diagram of the data processing device 100 according to the present subject matter. The data processing device 100 can be implemented in a vehicle.

The data processing device 100 can implement the above-mentioned method for device for performing speech-based human machine interaction. The data processing device 100 comprises a receiving module 111 adapted to receive a speech of a user; a determining module 112 adapted to determine whether a response to the speech of the user can be generated; a sending module 113 adapted to send information corresponding to the speech of the user to the call center; an establishing module 114 adapted to establish a phone call between the user and a call center; and an artificial intelligence assistant module 115, which is configured to find the suitable response to the drive's requirement as well as to conduct the operation corresponding to the user's intention.

The determining module 112 comprises a recognizing module adapted to recognize, by using natural language understanding, NLU, an intention of the user according to the speech, a response generating module adapted to generate the response according to the recognized intention of the user, and a deciding module adapted to decide whether the response can be generated by the response generating module.

Furthermore, the sending module 113 comprises a storing module adapted to store the speech of the user; and a speech sending module adapted to send the speech to the call center. Alternatively and additionally, the sending module 113 comprises a generating module adapted to generate text information according to the speech; and a text sending module adapted to send the text information to the call center. Accordingly, both of the speech of the driver and the text information interpreted according to the speech can be send to the call center so that the human assistant in the call center can the user clearly understand.

Additionally, the speech of the driver which the artificial intelligence assistant module cannot deal with correctly and the answer of the human assistant can be sent to the artificial intelligence assistant module and analyzed. Such data can complement the data base in the artificial intelligence assistant module and are very necessary for training the artificial intelligence assistant. Therefore, the questions that artificial intelligence assistant was not able to answer can be solved by the artificial intelligence assistant by using the updated data base. The performance of the artificial intelligence assistant can thus be improved.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for performing speech-based human machine interaction (HMI), comprising:
obtaining a speech of a user;
determining whether a response to the speech of the user can be generated; and
if no response can be generated, sending information corresponding to the speech of the user to the call center.

2. The method according to claim 1, further comprising:
establishing a phone call between the user and a call center.

3. The method according to claim 1, wherein
the step of determining whether a response to the speech of the user can be generated further comprises:
recognizing, by using natural language understanding, NLU, an intention of the user according to the speech.

4. The method according to claim 3, wherein
the step of determining whether a response to the speech of the user can be generated further comprises:
deciding whether the response can be generated; and
generating the response according to the recognized intention of the user.

5. The method according to claim 1, wherein
the step of sending information corresponding to the speech of the user to the call center further comprises:
storing the speech of the user; and
sending the speech to the call center.

6. The method according to claim 1, wherein
the step of sending information corresponding to the speech of the user to the call center further comprises:
generating text information according to the speech; and
sending the text information to the call center.

7. A data processing device for performing speech-based human machine interaction (HMI), comprising:
an obtaining module to obtain a speech of a user;
a determining module to determine whether a response to the speech of the user can be generated; and
a sending module to send information corresponding to the speech of the user to the call center.

8. The data processing device according to claim 7, further comprising:
an establishing module to establish a phone call between the user and a call center.

9. The data processing device according to claim 7, wherein
the determining module comprises:
a recognizing module to recognize, by using natural language understanding, NLU, an intention of the user according to the speech.

10. The data processing device according to claim 9, wherein
the determining module further comprises:
a response generating module to generate the response according to the recognized intention of the user; and
a deciding module to decide whether the response can be generated by the response generating module.

11. The data processing device according to claim 7, wherein
the sending module comprises:
a storing module to store the speech of the user; and
a speech sending module to send the speech to the call center.

12. The data processing device according to claim 7, wherein
the sending module comprises:
a generating module to generate text information according to the speech; and
a text sending module to send the text information to the call center.

13. The data processing device according to claim 7, wherein
the data processing device is installed within a vehicle.

14. A data processing device for performing speech-based human machine interaction (HMI), comprising:
a processor;
a memory in communication with the processor, the memory storing a plurality of instructions executable by the processor to cause the data processing device to:
obtain a speech of a user;
determine whether a response to the speech of the user can be generated; and
if no response can be generated, send information corresponding to the speech of the user to the call center.

15. The data processing device according to claim 14, wherein
the memory further comprises instructions to cause the data processing device to:
establish a phone call between the user and a call center.

16. The data processing device according to claim 14, wherein
the memory further comprises instructions to cause the data processing device to:
recognize, by using natural language understanding, NLU, an intention of the user according to the speech.

17. The data processing device according to claim 16, wherein
the memory further comprises instructions to cause the data processing device to:
decide whether the response can be generated; and
generate the response according to the recognized intention of the user.

18. The data processing device according to claim 14, wherein
the memory further comprises instructions to cause the data processing device to:
store the speech of the user; and
send the speech to the call center.

19. The data processing device according to claim 14, wherein
the memory further comprises instructions to cause the data processing device to:
generate text information according to the speech; and
send the text information to the call center.
